(19) United States
(12) Patent Application Publication
(10) Pub. No.: US 2024/0400797 A1
(43) Pub. Date: Dec. 5, 2024

(54) CORE-SHELL TYPED COMPOSITE FILLER WITH HIGH THERMAL CONDUCTIVITY, POLYMER COMPOSITE MATERIAL COMPRISING THE SAME, AND METHOD FOR MANUFACTURING THE SAME

(71) Applicant: KOREA INSTITUTE OF SCIENCE AND TECHNOLOGY, Seoul (KR)

(72) Inventors: Cheol-Min YANG, Wanju-gun (KR); Woo Ree JANG, Wanju-gun (KR); Namryeol KIM, Wanju-gun (KR); Seo Yun LEE, Wanju-gun (KR); Sangki PARK, Wanju-gun (KR)

(21) Appl. No.: 18/676,806

(22) Filed: May 29, 2024

(30) Foreign Application Priority Data
May 31, 2023 (KR) 10-2023-0069681

(51) Int. Cl. C08K 9/10

(52) U.S. Cl. CPC C08K 9/10; C08K 2201/003; C08K 2201/011; C08K 2201/013

(57) ABSTRACT

The present invention relates to a core-shell typed composite filler including: a core including a thermosetting polymer resin; and a shell including a plurality of first nano/micro materials positioned on a surface of the core, and to a polymer composite material with the same applied. Further, the present invention also relates to a method of manufacturing a polymer composite material, the method includes: forming the core-shell typed composite filler; and dispersing the core-shell typed composite filler and the second nano/micro material into a polymer matrix.

### CROSS REFERENCE TO RELATED APPLICATION

The present application claims priority to Korean Patent Application No. 10-2023-0069681, filed May 31, 2023, the entire contents of which is incorporated herein for all purposes by this reference.

### BACKGROUND OF THE INVENTION

### Field of the Invention

The present application relates to a core-shell typed composite filler with high thermal conductivity, a polymer composite material including the same, and a method of manufacturing the same, and discloses a polymer composite material having excellent heat dissipation performance in an axial direction.

### Description about National Research and Development Support

This study was supported by the technology development programs of Ministry of Trade, Industry and Energy, Republic of Korea (Projects No. 1415179516) under the superintendence of Korea Planning and Evaluation Institute of Industrial Technology.

Further, this study also was supported by the technology development programs of Ministry of Science and ICT, Republic of Korea (Projects No. 1711196536) under the superintendence of Korea Institute of Science and Technology.

### Description of the Related Art

Recently, highly functional polymer composite materials have attracted attention in various industrial fields such as aerospace, automotive, electrical/electronics, and energy. In particular, with the rapid development of the electronics industry, electronic devices have been miniaturized, integrated, and highly functionalized in addition to improving performance, and the recent popularization of electric vehicles and the emergence of autonomous vehicles have greatly increased the demand for more efficient heat transfer material application technologies. For this reason, the effective dissipation of heat generated during device operation has become an important challenge to ensure the reliability, durability, and safety of electronics and next-generation vehicles. Therefore, much research has been focused on the development of high-performance, lightweight heat dissipating polymer composite materials to solve these problems.

In order to manufacture a polymer composite material with excellent properties, it is important to form a continuous network with a uniform dispersion of a filler in a polymer resin and a minimum content of filler. In particular, in case of nano/micro material fillers, although they have excellent inherent properties, it is very difficult to satisfy the performance of polymer composite materials required by the industry without high content filling in the polymer resin, and the higher the content of nano/micro material fillers, the more the fluidity of the resin is lost, and the characteristics such as processability, mechanical properties, and specific gravity are reduced.

Therefore, when manufacturing the functional polymer composite material, it is essential to develop a composite material manufacturing technology that can achieve the required properties such as heat dissipation, electrical conductivity, flame retardancy, and electromagnetic wave shielding properties required by various industries through efficient network formation of the filler while filling the minimum content of the filler.

### SUMMARY OF THE INVENTION

As described above, by solving the problem in that when conventional nano/micro material fillers are compounded with the polymer at a high content, the fluidity of the resin is lost and characteristics such as processability, mechanical properties, and specific gravity are deteriorated, the present invention is directed to providing a polymer composite material that can be uniformly dispersed in the polymer resin and efficiently form a continuous network even with a low content of filling.

According to an embodiment of the present invention, there is provided a core-shell typed composite filler, including a core that includes a thermosetting polymer resin; and a shell that includes a plurality of first nano/micro materials positioned on a surface of the core.

In an embodiment, the first nano/micro material may be selected from spherical, amorphous, plate-like, and linear shapes and may have a diameter, length, or thickness that ranges from 0.001 to 100 μm.

In an embodiment, the first nano/micro material may be included at 5 to 20 wt % relative to a total weight of the core-shell typed composite filler.

In an embodiment, the first nano/micro material may include one or more resins selected from the group consisting of BN, AlN, SiO₂, Al₂O₃, MgO, MgCO₃, SiC, Si₃N₄, BeO, TiO₂, TiB₂, ZnO, metal powder (Cu, Al, Ag, Fe, Sn, Ni, or Zn), graphite, expanded graphite, graphene, graphene oxide (GO), reduced graphene oxide (RGO), graphene nanoplatelets (GNP), multi-walled carbon nanotube (MWCNT), single-walled carbon nanotube (SWCNT), single-walled carbon nanohorn (SWCNH), carbon fiber, carbon nanofiber, activated carbon, carbon black, MXene, ferrite, and metal oxide.

In an embodiment, the core may include a thermosetting polymer resin crosslinked with a curing agent of a polyamine, polyamide, or amine adduct.

In an embodiment, the curing agent may be cross-linked with the thermosetting polymer resin to adhere the first nano/micro material to a surface of the core.

In an embodiment, the thermosetting polymer resin may include one or more resins selected from the group consisting of epoxy resins, phenol-formaldehyde resins, urea-formaldehyde resins, melamine resins, silicone resins, and unsaturated polyester resins.

In another embodiment according to the present invention, there is provided a polymer composite material including the core-shell typed composite filler described above, a second nano/micro material, and a polymer matrix in which the core-shell typed composite filler and the second nano/micro material are dispersed.

In an embodiment, the polymer composite material may include a network structure formed by direct contact of one or more of the core-shell typed composite filler and the second nano/micro material, and the network may have a heat transfer characteristic in an in-plane direction and a through-plane direction.

In an embodiment, the second nano/micro material may be included in 0 to 80 wt % relative to the total weight of the polymer composite material.

In an embodiment, the second nano/micro material may include a filler having one or more sizes.

In an embodiment, the second nano/micro material may be selected from spherical, amorphous, plate-like, and linear shapes and may have a diameter, length, or thickness that ranges from 1 to 900 μm.

Specifically, in selecting a diameter of the second nano/micro material, it is proper to select the second nano/micro material that is approximately 2 to 3 times larger than the particle size of the core-shell typed composite filler.

In still another embodiment according to the present invention, there is provided a method of manufacturing a polymer composite material, the method includes: forming the core-shell typed composite filler as described above; and dispersing the core-shell typed composite filler and the second nano/micro material into a polymer matrix.

In an embodiment, the forming of the core-shell typed composite filler may be performed as a one-pot process, in which the size and uniformity of the core-shell typed spherical composite particles may be controlled by adjusting the RPM and time during the process of stirring the solution.

In an embodiment, the forming of the core-shell typed composite filler may include curing the polymer resin at a condition of room temperature to 150° C. for 2 to 24 hours.

In the polymer composite material according to an embodiment of the present invention, the core-shell typed spherical composite filler surrounded by the nano/micro material self-assembled on the surface of the polymer resin can be manufactured through a simple one-pot emulsion polymerization process without the need for multiple steps of complicated manufacturing processes. In particular, by providing the polymer composite material that can be uniformly dispersed in the polymer resin and efficiently form a continuous network even with a low content of filling, it is possible to improve the problem of deterioration of the fluidity, processability, and mechanical properties of the polymer composite material caused by filling with a high content of filler.

In addition, it is possible to control the orientation of boron nitride, which exhibits anisotropy of thermal conductivity due to the two-dimensional structure thereof within the polymer composite material, by introducing the core-shell typed structure surrounded by boron nitride (BN) through self-assembly on the surface of the polymer core such as epoxy resin, and thereby achieving excellent heat dissipation performance not only in an in-plane direction but also in a through-plane direction.

### BRIEF DESCRIPTION OF THE DRAWINGS

FIG. 1 is a schematic view illustrating a core-shell typed composite filler according to an embodiment of the present invention and a method of manufacturing a polymer composite material with the same applied.

FIG. 2A illustrates a scanning electron microscope (SEM) image of a core-shell typed composite filler of Example 1 with a 10 wt % content of boron nitride.

FIG. 2B illustrates a scanning electron microscope image of the core-shell typed composite filler of Example 1 with a 20 wt % content of boron nitride.

FIG. 3 illustrates a scanning electron microscope (SEM) image of a cross-section of the core-shell typed composite filler of Example 1.

FIG. 4A illustrates a thermogravimetric analysis (TGA) graph in an air atmosphere of the core-shell typed composite filler of Example 1 with a 10 wt % content of boron nitride.

FIG. 4B illustrates a thermogravimetric analysis graph in an air atmosphere of the core-shell typed composite filler of Example 1 with a 20 wt % content of boron nitride.

FIG. 5 illustrates a size distribution diagram of the core-shell typed composite filler according to an embodiment of the present invention.

FIG. 6 illustrates a scanning electron microscope image of a cross-section of a polymer composite material according to Example 2 of the present invention.

FIG. 7 illustrates an image of a sample with reduced graphene oxide (RGO) instead of boron nitride applied to the shell in the core-shell typed composite filler according to an embodiment of the present invention.

FIG. 8A illustrates a graph comparing through-plane thermal conductivities of polymer composite materials according to Example 2 and Comparative Example 1 of the present invention.

FIG. 8B illustrates a graph comparing in-plane thermal conductivities of the polymer composite materials according to Example 2 and Comparative Example 1 of the present invention.

FIG. 8C illustrates a graph comparing through-plane thermal conductivities of samples with various sizes of boron nitride as a second nano/micro material applied in the polymer composite material according to Example 2 of the present invention.

FIG. 9A is a scanning electron microscope image of a cross-section of the polymer composite material according to Example 2 of the present invention, illustrating an orientation of the boron nitride within the polymer composite material incorporating a core-shell typed composite filler.

FIG. 9B is a scanning electron microscope image of a cross-section of the polymer composite material according to Comparative Example 1 of the present invention, illustrating an orientation of the boron nitride within the polymer composite material.

FIG. 10 illustrates a graph comparing volume electrical resistivities of the polymer composite materials according to Example 2 of the present invention.

FIG. 11A illustrates a graph comparing storage modulus of thermal mechanical properties of polymer composite materials according to Example 2 and Comparative Example 1 of the present invention.

FIG. 11B illustrates a graph comparing ratios of storage modulus and loss modulus of thermal mechanical properties of the polymer composite materials according to Example 2 and Comparative Example 1 of the present invention.

FIG. 12 illustrates a scanning electron microscope image of a core-shell typed composite filler with aluminum oxide (Al₂O₃) applied instead of boron nitride in the shell according to an embodiment of the present invention.

FIG. 13 illustrates a scanning electron microscope image of a core-shell typed composite filler with silicon dioxide (SiO₂) applied instead of boron nitride in the shell according to an embodiment of the present invention.

FIG. 14 illustrates a scanning electron microscope image of a core-shell typed composite filler with a multi-walled carbon nanotube (MWCNT) applied instead of boron nitride in the shell according to an embodiment of the present invention.

FIG. 15 illustrates a scanning electron microscope image of a core-shell typed composite filler with MXene applied instead of boron nitride to the shell according to an embodiment of the present invention.

FIG. 16 illustrates a scanning electron microscope image of a core-shell typed composite filler with silicon resin applied instead of epoxy resin to the core according to one embodiment of the present invention.

FIG. 17 illustrates a table of sizes of spherical composite polymer resin core particles depending on stirring speed, according to an embodiment of the present invention.

FIG. 18 illustrates size distribution of spherical composite polymer resin core particles when manufactured at a stirring speed of 5000 rpm according to an embodiment of the present invention.

### DETAILED DESCRIPTION OF THE INVENTION

Hereinafter, exemplary embodiments of the present invention will be described in detail with reference to the accompanying drawings.

The embodiments of the present invention disclosed herein are illustrated for purposes of description only, and the embodiments of the present invention may be practiced in various forms and should not be interpreted as limiting to the embodiments described herein.

The present invention is subject to various modifications and may have various forms, and the embodiments are not intended to limit the present invention to any particular disclosure form, but are to be understood to include all modifications, equivalents, or substitutions that fall within the scope of the spirit and art of the present invention.

Singular expressions include plural expressions unless clearly described as different meanings in the context. In the present application, the terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

### [Core-Shell Typed Composite Filler]

According to an embodiment of the present invention, there is provided a core-shell typed composite filler, including a core that includes a thermosetting polymer resin; and a shell that includes a plurality of first nano/micro materials positioned on a surface of the core.

In an exemplary embodiment, the thermosetting polymer resin, unlike thermoplastics, is stable in properties and shape under external physical forces (high temperature and pressure), thereby enabling stable shape maintenance and good heat transfer in an axial direction for an effective thermal network. In an exemplary embodiment, the core-shell structure enables size control of the nano/micro materials self-assembled on a polymer resin surface, and may be applied to various materials such as ceramics, carbon, metal series, and the like, thereby enabling applications in various industrial fields.

In addition, since the core-shell typed composite filler is manufactured in a one-pot process system, the process time may be reduced.

In an exemplary embodiment, the first nano/micro material may include one or more of a ceramic material such as BN, AlN, SiO₂, Al₂O₃, SiC, or BeO, a carbon material such as graphite, expanded graphite, graphene, graphene oxide (GO), reduced graphene oxide (RGO), graphene nanoplatelets (GNP), multi-walled carbon nanotube (MWCNT), single-walled carbon nanotube (SWCNT), single-walled carbon nanohorn (SWCNH), carbon fiber, carbon nanofiber, activated carbon, or carbon black, and a metal material such as MXene, ferrite, or metal oxide. Preferably, the first nano/micro material may be boron nitride. Depending on the characteristics of the first nano/micro material, various functionalities (electrical conductivity, flame retardancy, electromagnetic wave shielding characteristic, etc.) may be added to the composite filler.

The first nano/micro materials described above may be bound to the polymer resin surface and are effective for heat transfer, thus forming a continuous heat transfer network in the axial direction.

Meanwhile, depending on the type and/or size of the first nano/micro material, a size of the core-shell typed composite filler finally obtained may vary. For example, reduced graphene oxide having a size of 100 μm or more may be applied as the first nano/micro material, in which case the core-shell typed composite filler may have a size of 1 to 2 mm, which is approximately 100 times larger compared to the case where boron nitride having a size of 1 μm is applied. Therefore, the size of the core-shell typed spherical composite filler may increase in proportion to an increase in the size of the added self-assembled nano/micro material filler.

In an exemplary embodiment, the first nano/micro material may have a diameter range of 0.001 to 100 μm, in which the diameter range may depend on a particle size of the spherical composite polymer resin core to be manufactured. For example, in case that the first nano/micro material with a diameter range of approximately 1/10 compared to the particle size of the spherical composite polymer resin core is applied, it is possible to obtain a uniform core-shell typed spherical composite filler particle.

In an exemplary embodiment, the first nano/micro material may be included at 5 to 20 wt % relative to a total weight of the core-shell typed composite filler. When the content of the first nano/micro material is less than 5 wt %, the thermal network may be blocked due to the exposure of the polymer resin that is the core, and when exceeding 20 wt %, a decrease in the homogeneity of the core-shell typed composite filler manufacturing due to an increase in the uneven shell thickness of the core-shell typed composite filler may occur. Also, the occurrence of thermal resistance due to an increase in an interface of the nano/micro material may result in a decrease in thermal conductivity.

In an exemplary embodiment, the core may include a thermosetting polymer resin crosslinked with a curing agent of a polyamine, polyamide, or amine adduct.

In an exemplary embodiment, the curing agent may be cross-linked with the thermosetting polymer resin to adhere the first nano/micro material to a surface of the core. In this case, the core-shell typed composite filler may be positioned in the form of a core (epoxy)-shell (BN) where the BN is directly attached. For example, the first nano/micro material, such as boron nitride powder, may be dispersed in an emulsion and self-assembled to a surface of the polymer resin core formed in a solution and cured. In this case, the first nano/micro material is added after the curing agent is added to adhere the first nano/micro material only to the surface of the polymer resin, which is the core. In this case, as the first nano/micro material has better miscibility with the curing agent, it may be easier to adhere to the polymeric resin surface. Therefore, the shell (BN), which is highly miscible with the curing agent, may be assembled together upon surface curing of the core polymer resin.

In an exemplary embodiment, the content of the curing agent is preferably in a 2:1 ratio relative to the polymer resin. However, when a ratio of the curing agent to the polymer resin increases by more than 2:1, the binding of the first nano/micro material self-assembled on the surface of the polymer resin and the formation of spherical composite may be hindered, and when the ratio of the curing agent to the polymer resin decreases by less than 2:1, the degree of curing of the polymer resin may decrease.

In an exemplary embodiment, the thermosetting polymer resin may include one or more resins selected from the group consisting of epoxy resins, phenol-formaldehyde resins, urea-formaldehyde resins, melamine resins, silicone resins, and unsaturated polyester resins.

### [Polymer Composite Material]

In another embodiment according to the present invention, there is provided a polymer composite material including the core-shell typed composite filler described above, a second nano/micro material, and a polymer matrix in which the core-shell typed composite filler and the second nano/micro material are dispersed.

In particular, by applying the core-shell typed composite filler to control anisotropy of thermal conductivity of a boron nitride filler with good thermal conductivity in an in-plane direction but low thermal conductivity in a through-plane direction within a polymer matrix, and to contribute to an increase in contact surfaces between the fillers and the formation of a continuous network, it is possible to have good thermal conductivity and insulation properties in the in-plane direction as well as in the through-plane direction with a small amount of thermally conductive filler incorporated. That is, the core-shell typed composite filler may form a three-dimensional skeletal structure inside the polymer composite material as well as serve as a filler for heat transfer.

In an exemplary embodiment, the second nano/micro material may include a heterogeneous nano/micro material capable of heat transfer, such as the first nano/micro material of various sizes, which may be added to impart different characteristics and properties to the polymer composite material. For example, the second nano/micro material may include one or more of a ceramic material such as BN, AlN, SiO₂, Al₂O₃, SiC, or BeO, a carbon material such as graphite, expanded graphite, graphene, graphene oxide (GO), reduced graphene oxide (RGO), graphene nanoplatelets (GNP), multi-walled carbon nanotube (MWCNT), single-walled carbon nanotube (SWCNT), single-walled carbon nanohorn (SWCNH), carbon fiber, carbon nanofiber, activated carbon, or carbon black, and a metal material such as MXene, ferrite, or metal oxide, and may be the same material as or different material from the first nano/micro material.

Meanwhile, the second nano/micro material is a two-dimensional material, and may have good thermal conductivity in the in-plane direction but poor thermal conductivity in the through-plane direction within the polymer matrix. However, when the second nano/micro material and the core-shell typed composite filler described above are applied together, it is possible to control the anisotropy of the low thermal conductivity of the two-dimensional nano/micro material in the through-plane direction to have excellent characteristic even in the through-plane direction.

In an exemplary embodiment, the polymer composite material may include a network structure formed by direct contact of one or more of the core-shell typed composite filler and the second nano/micro material, and the network may have a heat transfer characteristic in an in-plane direction and a through-plane direction. Specifically, such a network structure may include direct contact between the core-shell typed composite fillers, direct contact between the second nano/micro materials, and/or direct contact between the core-shell typed composite filler and the second nano/micro material.

In particular, when the core-shell typed composite filler and the second nano/micro material are incorporated into the polymer composite material, the orientation of the second nano/micro material, which is two-dimensional, may be oriented not only in the in-plane direction of the polymer composite material but also in the through-plane direction thereof. In addition, as the content of the core-shell typed composite filler increases, contact surfaces between the core-shell typed composite fillers, contact surfaces between the second nano/micro materials, or contact surfaces of the core-shell typed composite filler and the second nano/micro material increase, which may be advantageous for the formation of a continuous network structure.

In an exemplary embodiment, the polymer composite material may include 4.2 to 5.3 vol % of the first nano/micro material, relative to a total weight of the polymer composite material. In an exemplary embodiment, the polymer composite material may include 18.0 to 33.0 vol % of the first nano/micro material and the second nano/micro material, relative to a total volume of the polymer composite material.

Therefore, even if the polymer composite material is filled with a high content of the core-shell typed composite filler itself, since the first nano/micro material is selectively positioned on a surface of the core-shell typed composite filler, the amount of nano/micro material (first nano/micro material and second nano/micro material) actually contained in the polymer composite material may be very small, thereby improving the processability, mechanical properties, etc. of the polymer composite material, which has been an existing problem.

In an exemplary embodiment, the second nano/micro material may be included in 0 to 80 wt % relative to the total weight of the polymer composite material. When the content of the second nano/micro material exceeds 80 wt %, it may be difficult to manufacture the polymer composite material or lead to deterioration of properties.

In an exemplary embodiment, the second nano/micro material may include a filler having one or more sizes. A diameter range of the second nano/micro material may depend on a particle size of the core-shell typed spherical composite filler. For example, the second nano/micro material may have the diameter range of 1 to 900 μm. Specifically, in selecting a diameter of the second nano/micro material, it is proper to select the second nano/micro material that is approximately 2 to 3 times larger than the particle size of the core-shell typed composite filler.

In a specific embodiment, where the particle size of the required spherical composite filler is 9 to 10 μm, the second nano/micro material may have the diameter range of 5 to 20 μm. When the diameter of the second nano/micro material is less than 5 μm, the heat transfer in the through-plane direction may be reduced due to thermal resistance caused by the increase in the contact surface of the nano/micro material, and when exceeding 20 μm, the sphericalization of the composite and the uniform dispersion of the nano/micro materials in the polymer composite material may be difficult.

### [Method of Manufacturing Polymer Composite Material].

In still another embodiment according to the present invention, there is provided a method of manufacturing a polymer composite material, the method includes: forming the core-shell typed composite filler as described above; and dispersing the core-shell typed composite filler and the second nano/micro material into a polymer matrix.

First, the core-shell typed composite filler may be formed.

In an exemplary embodiment, a core of the core-shell typed composite filler may include a thermosetting polymer formed by polymerizing a monomer. For example, the monomer may include one or more monomers selected from the group consisting of bisphenol-A, bisphenol-F, phenol, urea, melamine, formaldehyde, isocyanate, polyol, and styrene.

The polymer resin formed by applying such a monomer may include one or more polymer resins selected from the group consisting of epoxy resin, phenol-formaldehyde resin, urea-formaldehyde resin, melamine resin, silicone resin, and unsaturated polyester resins, and may preferably be epoxy resin.

In an exemplary embodiment, the forming of the core-shell typed composite filler may be performed in a one-pot process. For example, the forming of the core-shell typed composite filler may be performed through a one-pot emulsion polymerization process, through which a composite filler having a core-shell typed structure in which the polymer resin is surrounded by a heterogeneous nano/micro material (ceramic, carbon, metal, etc.) may be formed.

In an exemplary embodiment, the size and uniformity of spherical polymer particles may vary depending on the speed and time at which a solution is stirred. The speed of the stirring process may be adjusted from 100 rpm to 10000 rpm, and as the speed increases, it is possible to obtain a spherical composite polymer resin core particle with a reduced size.

Therefore, by adjusting the stirring speed, it is possible to obtain a wide range of core-shell typed spherical composite filler particles of the size required by industry. Meanwhile, when a surfactant is added to the polymer resin core and a distilled water solution and then the mixture is stirred for 12 to 24 hours, a uniform polymer resin core may be obtained. For example, when the mixture is stirred for 12 hours or less, the uniformity of core-shell typed spherical composite filler particle size decreases rapidly, and when stirred for 24 hours or more, the uniformity of core-shell typed spherical composite filler particle size does not improve further.

In addition, the size of the manufactured spherical composite filler may vary depending on the type (molecular weight) of surfactant applied.

In an exemplary embodiment, the forming of the core-shell typed composite filler may include curing the polymer resin at a condition of room temperature to 150° C. for 2 to 24 hours. Meanwhile, the yield of spherical composite filler may vary depending on the temperature and time of curing the polymer resin. For example, when epoxy is used as a spherical composite polymer resin core, the curing time may decrease from 10 hours to 2 hours and the yield may increase from approximately 10 wt % to 90 wt % by increasing the curing temperature from 90° C. to 120° C.

Next, the core-shell typed composite filler and the second nano/micro material may be dispersed in the polymer matrix using dispersion equipment (Thinky mixer, Three-roll mill), and the polymer composite material used for heat dissipation film/sheet types and heat dissipation parts may be manufactured through a hot-press compression process and injection molding of the polymer matrix in which the core-shell typed composite filler and the second nano/micro material are dispersed. In addition, depending on the core-shell typed composite filler in the polymer matrix resin, the content of the second nano/micro material, or the type of polymer matrix resin and compound additives, low and high viscosity pastes may be manufactured. For example, a paste with a viscosity of up to 80000 cP may be manufactured by adjusting the content of nano/micro materials in the polymer matrix resin. Therefore, the core-shell typed composite filler with high thermal conductivity and the polymer composite material including the same can be applied in a wide range of applications such as heat dissipation sheet, tape, grease, gap filler, thermal interface material (TIM), coating agent, adhesive/bonding agent, etc. in the automotive field including automobile batteries and electrical/electronic field including semiconductors.

Different heterogeneous resins from the polymer of the core-shell typed composite filler may be used as the polymer matrix, depending on the purpose of use of the polymer composite material. For example, in applications that require the elasticity and flexibility of the composite material, silicone-based polymer resin may be used.

The polymer composite material manufactured as described above can be uniformly dispersed in the polymer resin and efficiently form a continuous network even when the filler is filled with a low content. This improves a problem of deterioration of the fluidity, processability, and mechanical properties of the polymer composite material caused by filling with a high content of filler.

### EXAMPLES

Hereinafter, the present invention will be described in more detail with reference to exemplary embodiments. These examples are just illustrative of the present invention, and it is apparent to one of ordinary skill in the art that the scope of the present invention is not to be interpreted as limited by these examples.

### Example 1: Manufacturing of Core-Shell Typed Composite Filler (e-BN)

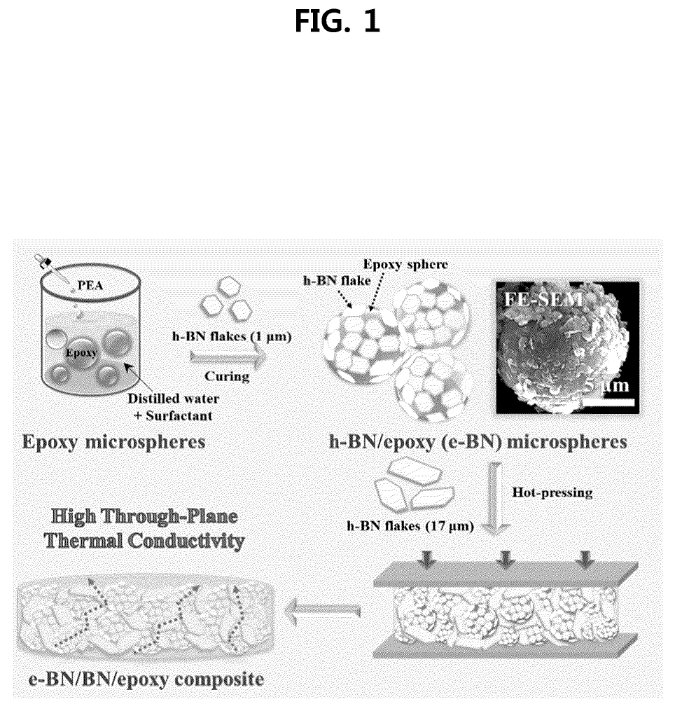

The core-shell typed composite filler (epoxy resin-BN) was manufactured by applying an emulsion polymerization one-pot process system, which is described with reference to FIG. 1.

In a 500 ml round flask, 10 g of epoxy resin (Kukdo Chemical YD-128), 100 ml of distilled water, and 0.5 g of surfactant (sodium dodecyl sulfate) were added and stirred thoroughly at 500 rpm at 80° C. for 24 hours. In this case, the surfactant was added at 5 wt % of the distilled water used. Then, 5 g of polyether amine (Jeffamine, Kukdo Chemical D-230) as a curing agent and 1 μm-sized boron nitride powder were added and stirred at 120° C. for two hours, and the resulting composite was washed with ethanol and distilled water. The curing agent was added dropwise at a 2:1 ratio to the epoxy resin, and 1 g of boron nitride, which is a nano/micro material self-assembled on a spherical epoxy surface, up to 1 μm in size, was added. Finally, boron nitride-epoxy resin spherical composite (e-BN) was obtained by freeze-drying. In the manufactured e-BN, the boron nitride surrounds the spherical epoxy surface dispersed in the emulsion by self-assembly.

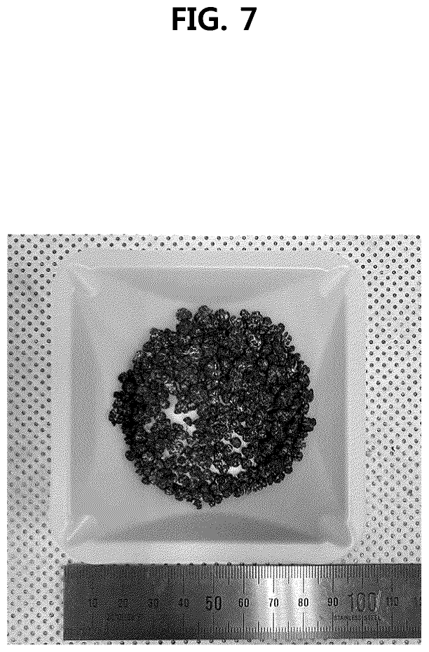

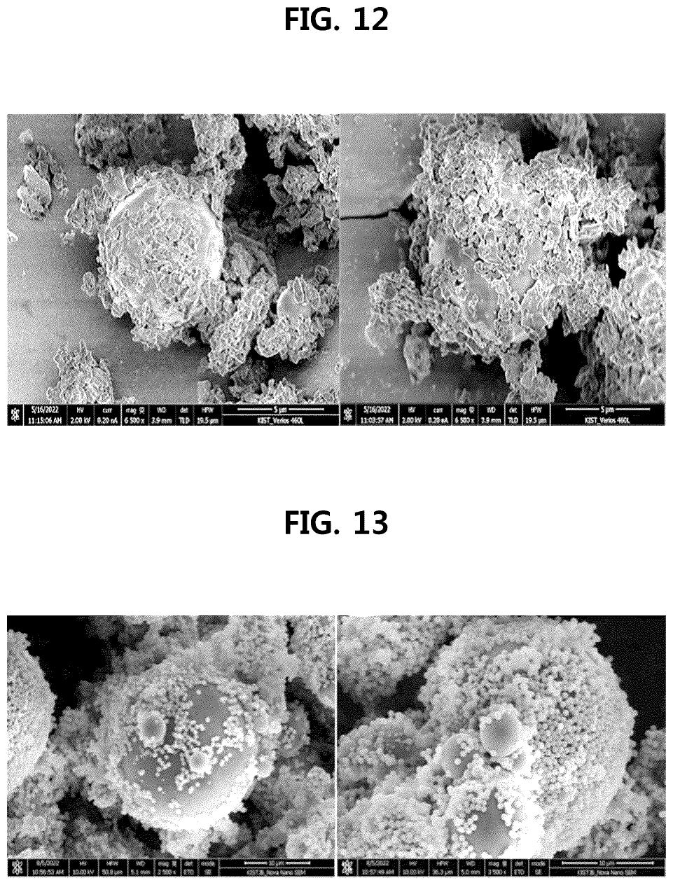

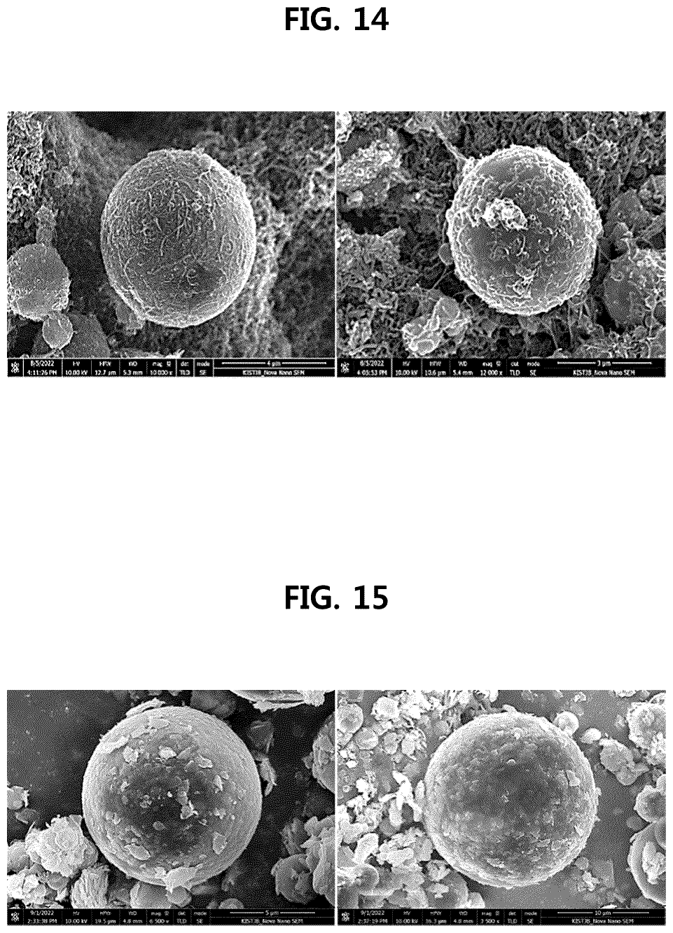

Meanwhile, when 100 μm-sized reduced graphene oxide is added instead of the boron nitride in the manufacturing process of Example 1, a reduced graphene oxide-epoxy resin core-shell typed spherical composite with increased size is manufactured, as illustrated in FIG. 7. This confirmed the applicability of carbon-based nano/micro materials and also confirmed that the size of the core-shell typed spherical composite increases proportionally with the increase in the size of the self-assembled nano/micro material filler. In addition, when amorphous aluminum oxide (Al₂O₃) having a size of 1 to 3 μm is added instead of the boron nitride in the manufacturing process of Example 1, an aluminum oxide (Al₂O₃)-epoxy resin core-shell typed spherical composite having a size of 5 to 10 μm is manufactured, as illustrated in FIG. 12. When spherical silicon dioxide (SiO₂) with a size of 600 to 800 nm is added instead of the boron nitride in the manufacturing process of Example 1, a silicon dioxide (SiO₂)-epoxy resin core-shell typed spherical composite with a size of 10-30 μm is manufactured, as illustrated in FIG. 13. When a one-dimensional multi-walled carbon nanotube (MWCNT) with a diameter of 40-60 nm is added instead of the boron nitride in the manufacturing process of Example 1, a one-dimensional multi-walled carbon nanotube (MWCNT)-epoxy resin core-shell typed spherical composite with a size of 3 to 5 μm is manufactured, as illustrated in FIG. 14. When two-dimensional MXene with a size of 1 to 3 μm is added instead of the boron nitride in the manufacturing process of Example 1, a MXene-epoxy resin core-shell typed spherical composite with a size of 5-10 μm is manufactured, as illustrated in FIG. 15.

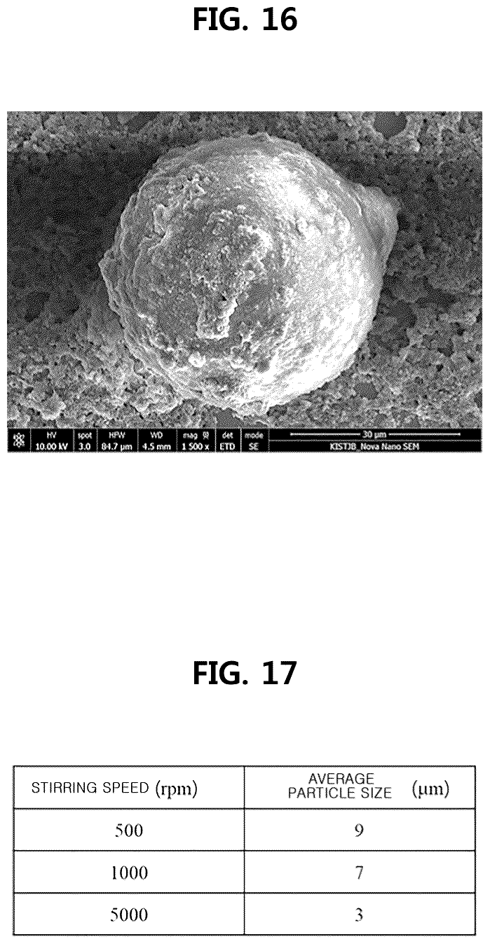

In addition, when silicone resin (polydimethylsiloxane) and silicone curing agent are added instead of the epoxy resin in the manufacturing process of Example 1, a core-shell typed spherical composite with a size of 40 to 50 μm is manufactured, as illustrated in FIG. 16.

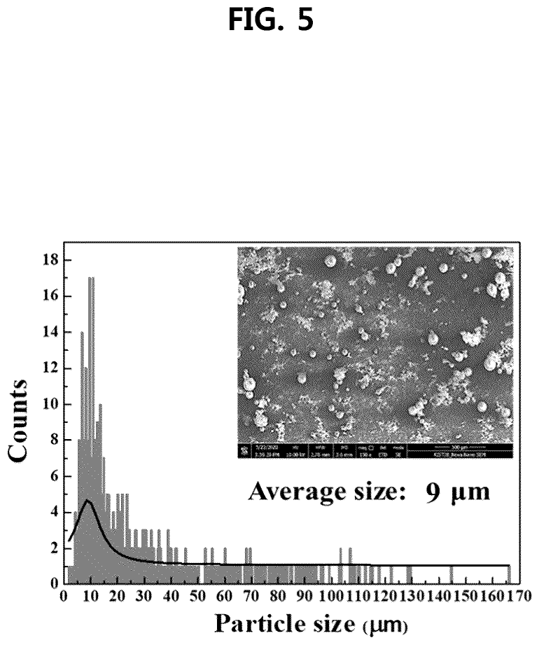

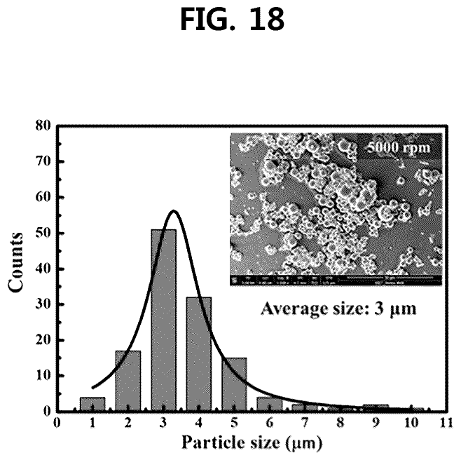

Meanwhile, as the stirring speed increases to 500, 1000, and 5000 rpm in the manufacturing of the spherical composite polymer resin core particles, the spherical composite polymer resin core with an average particle size further reduced to 9, 7, and 3 μm is manufactured as illustrated in FIG. 17, and the distribution of the spherical composite polymer resin core particles manufactured by stirring at 5000 rpm is illustrated in FIG. 18. As illustrated in FIG. 5, the boron nitride-epoxy resin core-shell typed spherical composite manufactured in Example 1 was manufactured with a size of approximately 9 μm.

With this, it was confirmed that the core-shell typed spherical composite filler can be applied by adjusting the size of the composite filler according to the purpose of use.

### Experimental Example 1: Characteristics of Core-Shell Typed Composite Filler

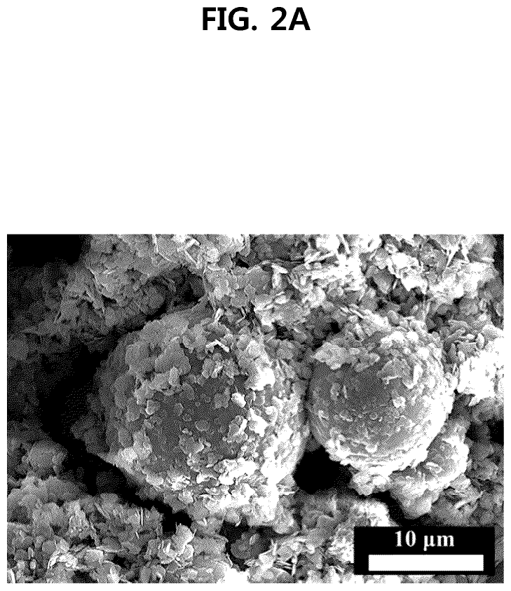

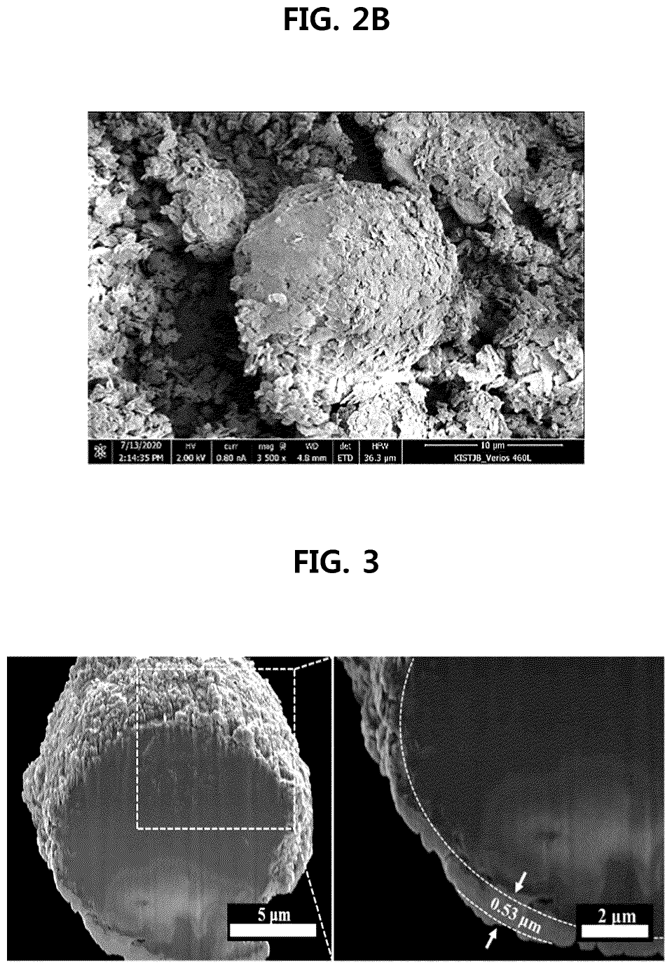

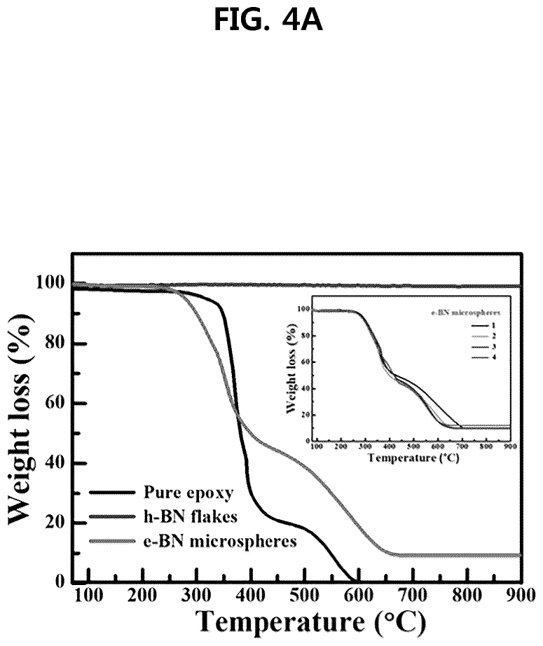

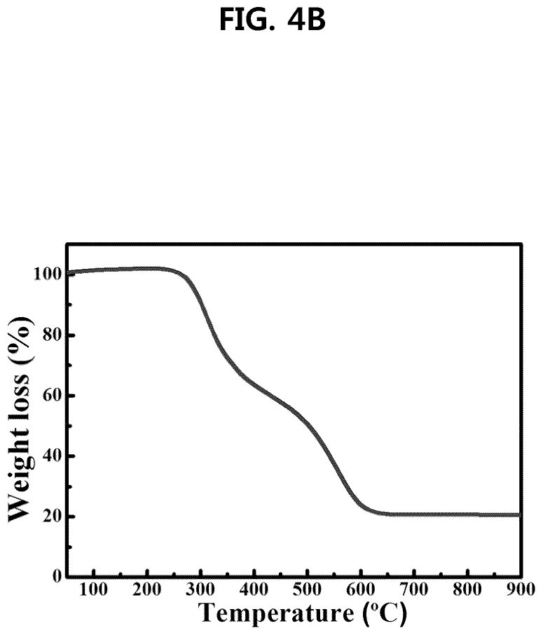

FIG. 2A illustrates a scanning electron micrograph of the boron nitride-epoxy resin core-shell typed spherical composite manufactured in Example 1, and FIG. 3 illustrates a cross-sectional scanning electron micrograph of the core-shell typed spherical composite. A thickness of the self-assembled boron nitride shell was confirmed to be 0.53 μm. It was confirmed that the amount of boron nitride in the core-shell typed spherical composite is approximately 10% of the composite when 1 g of 1 μm-sized boron nitride powder is added through thermogravimetric analysis in FIG. 4A. An average value was confirmed with the four-time measurement of the TGA.

In addition, it was confirmed that when the amount of 1 μm-sized boron nitride powder was added in 2 g, which is twice as much as in the manufacturing process of Example 1, the amount of boron nitride self-assembled in the core-shell typed spherical composite was proportionally increased to 20%, which is twice as much as in the manufacturing process of Example 1. This is illustrated by the electron micrograph in FIG. 2B and the thermogravimetric analysis graph in FIG. 4B.

As illustrated in FIG. 5, the boron nitride-epoxy resin core-shell typed spherical composite manufactured in Example 1 was manufactured with a size of approximately 9 μm.

### Example 2: Manufacturing of Polymer Composite Material (EB/BN/Epoxy Composite)

With reference to FIG. 1, the boron nitride powder (the second nano/micro material) having a size of 17 μm, which is a two-dimensional nano/micro material, is additionally added and mixed at a content of 30 wt % (e-BN/BN/epoxy(30)), 40 wt % (e-BN/BN/epoxy(40)), and 50 wt % (e-BN/BN/epoxy(50)), respectively, to the boron nitride-epoxy resin core-shell typed spherical composite filler manufactured in Example 1. Then, the polymer composite material (e-BN/BN/epoxy composite) was manufactured by curing the mixture for 2 hours under pressure at 120° C. using hot pressing equipment. A small amount of epoxy was added to serve as a bonding agent to prevent cracking of the mixed powder.

### Comparative Example 1: Manufacturing of Polymer Composite Material (BN/Epoxy Composite)

To confirm a difference depending on the presence or absence of the core-shell typed spherical composite, a polymer composite material (BN/epoxy composite) was manufactured by the same method as in Example 2, except that the core-shell typed spherical composite of Example 1 was not applied, the content of 1 μm-sized boron nitride (the first nano/micro material) and the content of 17 μm-sized additional boron nitride (the second nano/micro material) were 10 and 20 wt % (BN/epoxy (30)), 10 and 30 wt % (BN/epoxy (40)), and 10 and 40 wt % (BN/epoxy (50)), respectively.

### Experimental Example 2: Characteristics of Polymer Composite Material (EB/BN/Epoxy Composite)

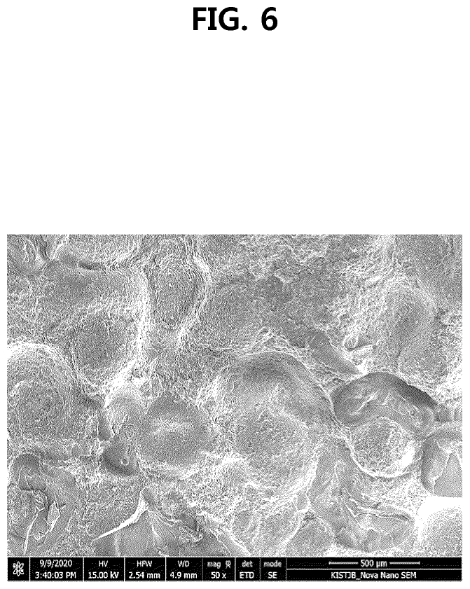

In FIG. 6, it was confirmed that by adding 17 μm-sized boron nitride as the second nano/micro filler, the voids between the core-shell typed spherical composites were able to be filled and the contact surfaces between the boron nitride fillers further increased. Such a structure can promote the continuous network of fillers to be provided, which can effectively improve the thermal conductivity of the polymer composite material.

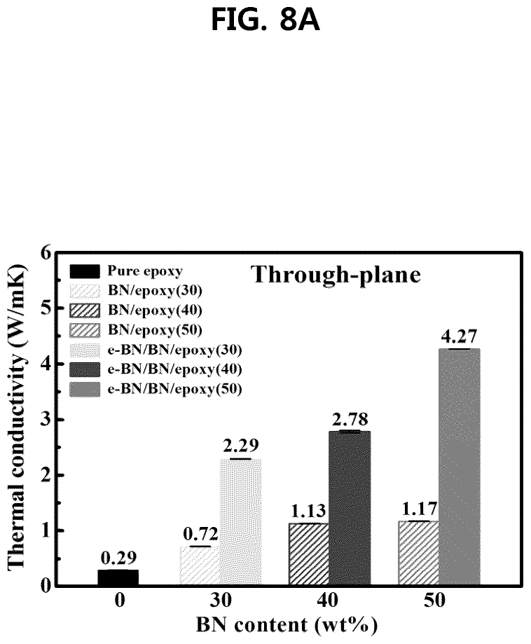

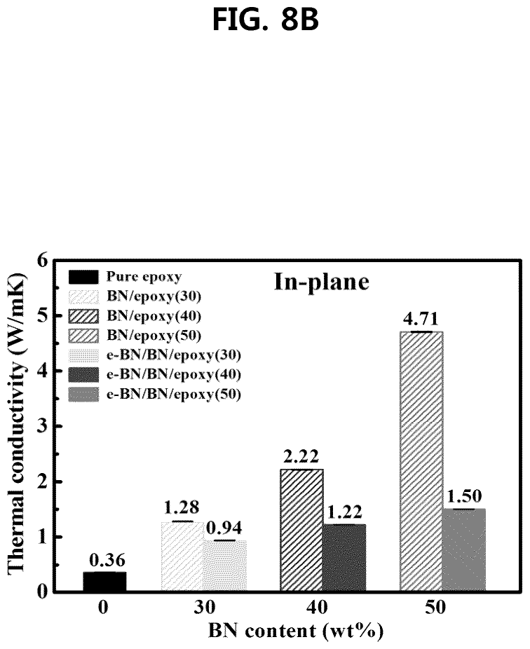

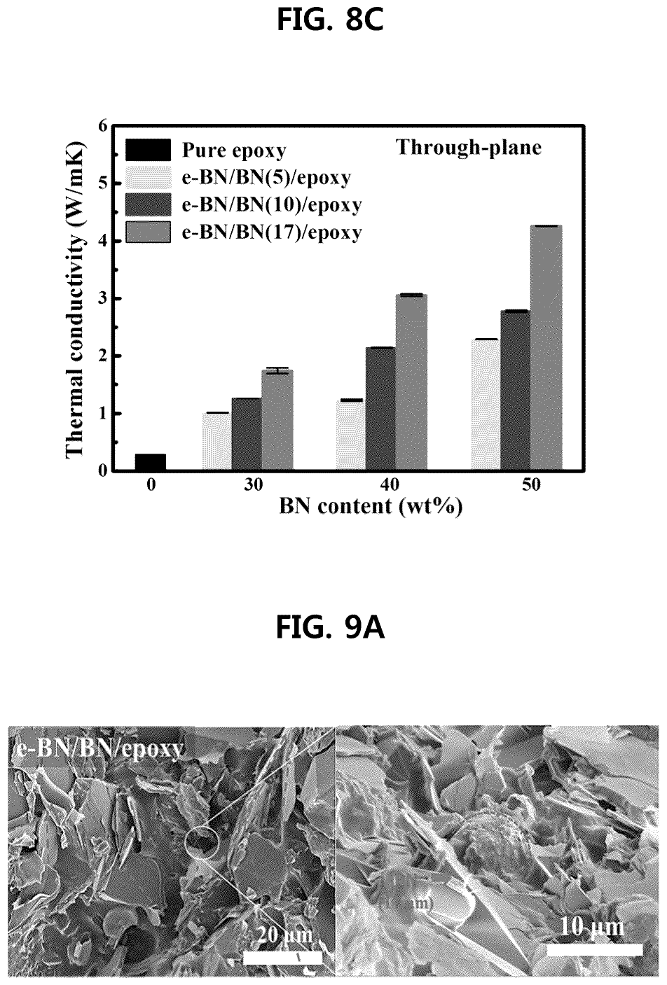

FIGS. 8A to 8C illustrate the thermal conductivities of the polymer composite materials of Example 2, e-BN/BN/epoxy(30), e-BN/BN/epoxy(40), and e-BN/BN/epoxy(50), which were manufactured by fixing the amount of boron nitride-epoxy resin core-shell typed spherical composite in the polymer composite material with the core-shell typed spherical composite applied and varying the amount of boron nitride additionally added. To confirm the difference in performance depending on the presence or absence of the core-shell typed spherical composite of Example 1, BN/epoxy (30), BN/epoxy (40), and BN/epoxy (50) were manufactured and compared by mixing only the same ratio and content of epoxy and boron nitride without applying the core-shell typed spherical composite as Comparative Example 1.

First, in FIG. 8A, it can be confirmed that the polymer composite material with the core-shell typed spherical composite filler of Example 1 applied exhibits an excellent thermal conductivity characteristic in the through-plane direction compared to the polymer composite material with the core-shell typed spherical composite filler not applied.

In addition, it was confirmed that the thermal conductivity improved with the increase in the content of boron nitride, which is the second nano/micro material, especially when the content of boron nitride was 50 wt %, the polymer composite material with the core-shell typed spherical composite exhibited the highest thermal conductivity of 4.27 W m⁻¹K⁻¹. Although the boron nitride, which is a two-dimensional nano/micro material, has the characteristic of being oriented in the in-plane direction, the spherical shape of the boron nitride surrounding the outer surface of the epoxy resin makes it easier to control the orientation of the boron nitride, thereby obtaining excellent thermal conductivity in the through-plane direction.

In addition, the second nano/micro material (BN, 17 μm) additionally added is larger in size compared to the 1 μm-sized boron nitride self-assembled in the core-shell typed spherical composite of Example 1, and the fillers of various sizes in such a polymer composite material are more effective in heat transfer due to the strengthening of the network and contact between the fillers, resulting in excellent thermal conductivity in the through-plane direction.

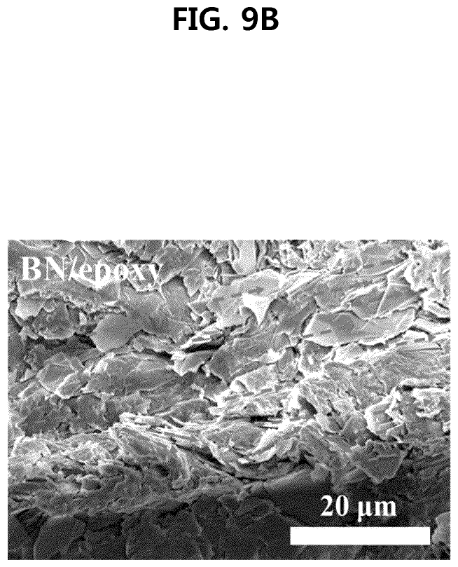

In FIGS. 9A and 9B, the orientation of the boron nitride can be seen in the cross-sections of the polymer composite material with the core-shell typed spherical composite of Example 2 applied and the polymer composite material with the core-shell typed spherical composite of Comparative Example 1 not applied. In the cross-sections observed by scanning electron microscopy, it was confirmed that the boron nitride in the polymer composite material with the core-shell typed spherical composite is vertically oriented, while the boron nitride in the polymer composite material without the core-shell typed spherical composite is relatively horizontally oriented.

In FIG. 8B, it can be confirmed that the in-plane thermal conductivity of the polymer composite material (Example 2) with the core-shell typed spherical composite applied is lower than that of the polymer composite material (Comparative Example 1) with the core-shell typed spherical composite not applied. It was confirmed that the polymer composite material that does not contain the spherical composite (Comparative Example 1) contains horizontally oriented boron nitride, which is more effective for heat transfer in the in-plane direction.

In FIG. 8C, the second nano/micro filler in the polymer composite material with the core-shell typed spherical composite of Example 2 applied was filled with the boron nitride fillers of different sizes of 5, 10, and 17 μm, respectively, to confirm the effect of the boron nitride size on the thermal conductivity characteristic in the through-plane direction. Depending on the boron nitride size added, the polymer composite material samples were referred to as e-BN/BN(5)/epoxy, e-BN/BN(10)/epoxy, and e-BN/BN(17)/epoxy.

As a result, it was confirmed that the thermal conductivity in the through-plane direction gradually increases as the boron nitride size additionally added in the polymer composite material with the core-shell typed spherical composite applied increases from 5 μm to 17 μm. This result showed that heat transfer is more effective when the fillers of different shapes and sizes are incorporated than when the fillers of the same shape and size are incorporated, and in particular, since the larger size of the fillers facilitates the control of the network and orientation of the fillers, the polymer composite material with 17 μm-sized boron nitride, e-BN/BN(17)/epoxy, exhibited the most excellent heat transfer characteristic in the through-plane direction.

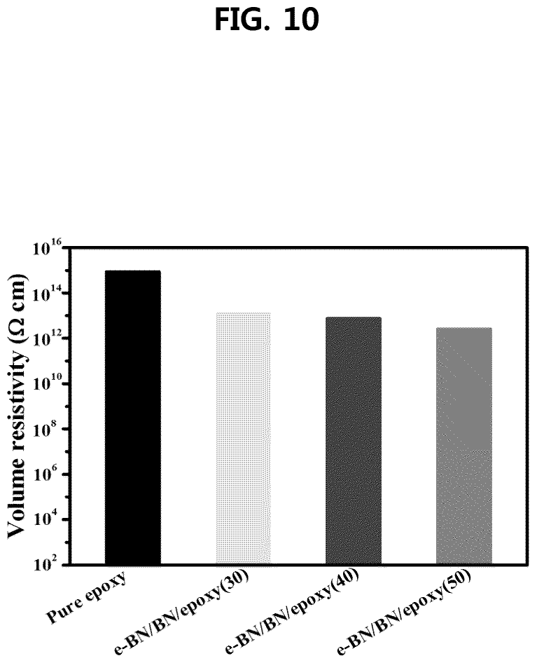

FIG. 10 is a volume resistivity measurement result of the polymer composite material with the core-shell typed spherical composite of Example 2 applied. As the content of boron nitride in the composite material increased, there was a slight decrease in the volume resistivity observed, however, overall, it was confirmed to have excellent insulation characteristics of a volume resistivity of 10¹²Ω cm or more.

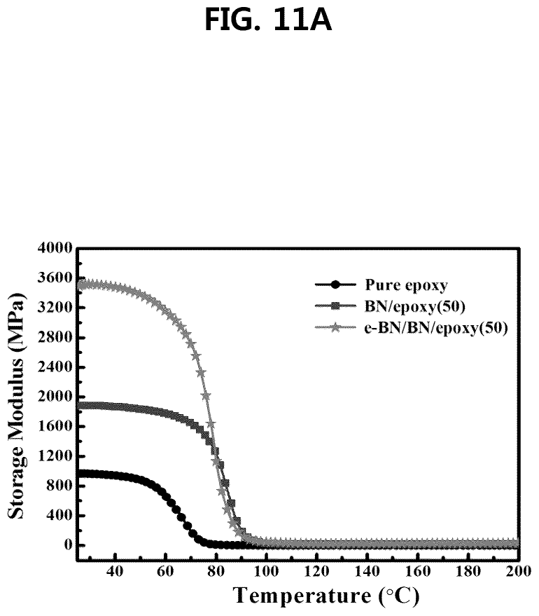

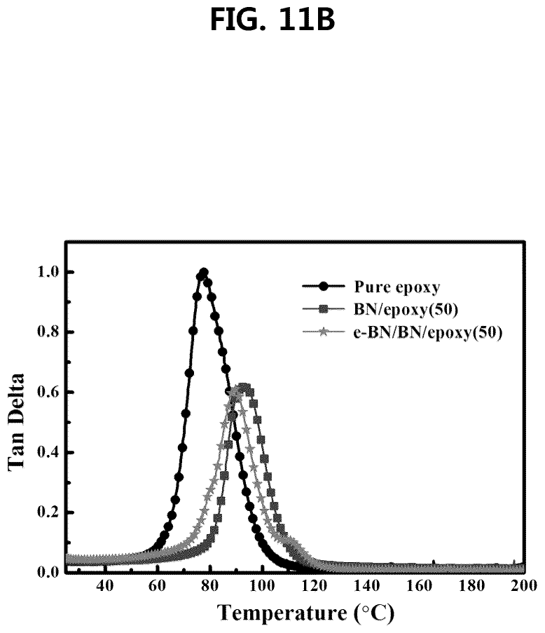

FIGS. 11A and 11B are measurement results of thermal mechanical properties of the polymer composite material with the core-shell typed spherical composite of Example 2 applied. When heat is applied to the polymer composite material, the behavior of the polymer resin is limited by the fillers incorporated therein, resulting in an increase in the storage modulus and glass transition temperature. In FIG. 11A, it can be confirmed that the storage modulus of the polymer composite material (e-BN/BN/epoxy (50)) with the spherical composite applied is more excellent compared to the polymer composite material (BN/epoxy (50)) with the core-shell typed spherical composite of Comparative Example 1 not applied. In addition, in FIG. 11B, it was confirmed that the polymer composite material with the core-shell typed spherical composite applied improved the mechanical properties by an increase in the glass transition temperature (maximum peak temperature) compared to the pure epoxy resin.

The embodiments of the present invention described above should not be interpreted as limiting the technical spirit of the present invention. It will be apparent to those skilled in the art that the scope of the present disclosure is limited only by the appended claims and various variations and modifications may be made without departing from the spirit and scope of the disclosure. Therefore, these variations and modifications will fall within the scope of the present disclosure as long as they are apparent to those skilled in the art.

### STATEMENT REGARDING PRIOR DISCLOSURES BY THE INVENTOR OR A JOINT INVENTOR

The inventors of the present application have made related disclosure in Wooree JANG et al., “Eco-friendly and scalable strategy to design electrically insulating boron nitride/polymer composites with high through-plane thermal conductivity,” Composites Part B, Vol. 248, No. 110355 on Oct. 14, 2022. The related disclosure was made less than one year before the effective filing date (May 31, 2023) of the present application. The authors of the related disclosure include two authors, Hyeyoung Koo and Jaesang Yu, who are not name as the joint inventors of the present application. However, they are graduate students or technicians worked under the direction and supervision of the joint inventors and do not contribute to the conception of the invention, and thus these authors are not joint inventors of the present application. Accordingly, the related disclosure is disqualified as prior art under 35 USC 102(a)(1) against the present application. See 35 USC 102(b)(1)(A).

What is claimed is:

1. A core-shell typed composite filler comprising:
a core including a thermosetting polymer resin; and
a shell including a plurality of first nano/micro materials positioned on a surface of the core.

2. The core-shell typed composite filler of claim 1, wherein the first nano/micro material has a diameter range of 0.001 to 100 μm.

3. The core-shell typed composite filler of claim 1, wherein the first nano/micro material is included at 5 to 20 wt % relative to a total weight of the core-shell typed composite filler.

4. The core-shell typed composite filler of claim 1, wherein the first nano/micro material comprises one or more resins selected from the group consisting of BN, AlN, SiO₂, Al₂O₃, SiC, BeO, graphite, expanded graphite, graphene, graphene oxide (GO), reduced graphene oxide (RGO), graphene nanoplatelets (GNP), multi-walled carbon nanotube (MWCNT), single-walled carbon nanotube (SWCNT), single-walled carbon nanohorn (SWCNH), carbon fiber, carbon nanofiber, activated carbon, carbon black, MXene, ferrite, and metal oxide.

5. The core-shell typed composite filler of claim 1, wherein the core comprises a thermosetting polymer resin crosslinked with a curing agent of a polyamine, polyamide, or amine adduct.

6. The core-shell typed composite filler of claim 5, wherein the curing agent is cross-linked with the thermosetting polymer resin to adhere the first nano/micro material to the surface of the core.

7. The core-shell typed composite filler of claim 1, wherein the thermosetting polymer resin comprises one or more resins selected from the group consisting of epoxy resins, phenol-formaldehyde resins, urea-formaldehyde resins, melamine resins, silicone resin, and unsaturated polyester resins.

8. A polymer composite material comprising:
the core-shell typed composite filler according to claim 1;
a second nano/micro material; and
a polymer matrix in which the core-shell typed composite filler and the second nano/micro material are dispersed.

9. The polymer composite material of claim 8, wherein the polymer composite material comprises a network structure formed by direct contact of one or more of the core-shell typed composite filler and the second nano/micro material, and
wherein the network has a heat transfer characteristic in an in-plane direction and a through-plane direction.

10. The polymer composite material of claim 8, wherein the second nano/micro material is included in 0 to 80 wt % relative to a total weight of the polymer composite material.

11. The polymer composite material of claim 8, wherein the second nano/micro material comprises a filler having one or more sizes.

12. The polymer composite material of claim 8, wherein the second nano/micro material has a diameter range of 1 to 900 μm.

13. A method of manufacturing a polymer composite material, the method comprising:
forming the core-shell typed composite filler according to claim 1; and
dispersing the core-shell typed composite filler and the second nano/micro material into a polymer matrix.

14. The method of claim 13, wherein the forming of the core-shell typed composite filler is performed in a one-pot process.

15. The method of claim 13, wherein the forming of the core-shell typed composite filler comprises a curing process at a condition of room temperature to 150° C. for 2 to 24 hours.
